(19) United States
(12) Patent Application Publication
(10) Pub. No.: US 2010/0251969 A1
(43) Pub. Date: Oct. 7, 2010

(54) PHC Portable Horse Cooler

(76) Inventor: Barry E Weatherbee, JR., Phoenix, AZ (US)

Correspondence Address: Barry E. Weatheree Jr., 3219 E. Camelback Road Building #481, Phoenix, AZ, 85018, US

(21) Appl. No.: 12/384,449

(22) Filed: Apr. 6, 2009

(51) Int. Cl. A01K 13/00

(52) U.S. Cl. 119/665

(57) ABSTRACT

The PHC Portable Horse Cooler is an insulated container of different sizes with wheels and a handle for easy transportation as well as it has an exterior battery, an exterior pump, a hose or hoses and a wand or wands for a cooling or bathing a horse or other animal. As the PHC Portable Horse Cooler has a pump, battery, and two hoses that allow water to flow to two wands that have a sprayer and a sweat scraper built in one. The battery and pump allow for use in almost any situation and/or location with out the use of a water hook up or an electrical outlet. It also allows for multiple uses as the battery has a built in rechargeable system. The person on each side can wet the horse with the hose and scrap off the water at the same time and then when finished cooling the horse off, the person can turn the off switch off the wand and scrap the horse off completely. This PHC Portable Horse Cooler apparatus allows the owners and volunteers to stay dry and requires less people to cool the horse which allows the horse to remain calm and the process can be accomplished more quickly. Also the PHC Portable Horse Cooler apparatus is on wheels and has a handle which when empty and dry, all of the hoses and wands can fit conveniently inside the cooler and can be wheeled easily and stored all together until it is needed again.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE OR COMPUTER PROGRAM LISTING COMPACT DISK APPENDIX

“Not Applicable”

### BACKGROUND OF THE INVENTION

Cooling off a horse using a bucket and sponge is known. The PHC Portable Horse Cooler for Horses mainly relates to cooling down a horse after exercise and/or to bath/clean a Horse. As horses that are involved in intense exercise they can become very hot and require help in reducing their body temperature for safety as well as for competition reasons. Other animals as well can become very warm as well as dirty and animals that require help in reducing body temperature as well as needing dirt cleaned off their exterior. Horses as well as other animals do most everything with people. As people exert themselves, so do other animals. When exerted or taken outdoors, animals eventually acquire an odor, dirt, plant matter and can become sweaty. The human owners then need to cool and bath the horse and/or animal were as to cool and/or clean the animal. The first important use is to cool down an animal, particularly a horse; currently it is a lengthy process that completely drenches the horse. With the current method this requires at least 5 people to cool down a horse safely and properly. This is done by having one person to hold the horse's head and two people on each side of the horse. One person on each side using a bucket and a sponge will start at the front of the horse's face and neck and begin sponging the horse off all the way to the tail and under the tail, the other person on the same side will follow the first person on the same side and scrap of the water as quickly as possible. The longer the water sets on the horse it begins to heat up and can trap in the heat you are washing off. This process also can make the horse angry and upset as it has more activity than they are accustom to and can make cooling the horse off difficult and a lengthy process. In cooling down a horse, the owner would need to provide and set up several large buckets of water and/ice sponges for each bucket; several sweat scrapers and have at least 5 people to help cool the horse down properly.

In a situation using a hose it restricts the owner to closes approximation to a hose connected to a faucet. The PHC Portable Horse Cooler allows for use almost anywhere in any environment without the need of a faucet.

A unique aspect of the present invention is an insulated container of different sizes with wheels and a handle for easy transportation as well as it has an exterior battery, an exterior pump, a hose or hoses and a wand or wands with holes for spraying and for cooling or bathing a horse or other animal that only requires one, two to three people depending on the owners needs. In a full cooling down of a horse one person is needed to hold the horse's head and one or two people to use the PHC Portable Horse Cooler. The current method to do the same amount of cooling would require three to five people. As the PHC Portable Horse Cooler has two hoses that allow water to flow to two wands that have a sprayer and a sweat scraper built in one it eliminates the need for an extra person per hose. The person on each side can wet the horse with the wand and scrap off the water at the same time, which keeps the water on the horse from heating up and allowing for more heat to escape at a quicker rate. This in turn allows the horse to cool down at a quicker pace, which is better for the horse's health. Then when finished cooling the horse off, the person can turn the switch to the off position and scrap the horse off completely. It also provides a constant flow of cool water as opposed to dipping a hot sponge into the water bucket heating up the water in the bucket. This PHC Portable Horse Cooler allows the owners and volunteers to stay dry and requires less people to cool the horse which allows the horse to remain calm and the process can be accomplished more quickly. The portable unit does not require an electric outlet when in use and only needs recharged upon occasion. This allows for the pump to be used just about any where with out the need of an electrical outlet. The use of a pump also allows the use just about any where as it eliminates the need for a faucet for the hose at the time of use. Also the PHC Portable Horses Cooler apparatus is on wheels and has a handle which allows for easy movements to the location of needed use. When empty and dry, all of the hoses and wands can fit conveniently inside the cooler and can be wheeled easily and stored all together until it is needed again. The insulated container can be filled with water and/or ice and transported just about anywhere.

Cooling horses systems and devices are known in the prior art. They involved using buckets, sponges, sweat scrapers, hoses attached to a faucet, Large Fans with misting systems attached, standing the horse under a tent with misting systems to try and rapidly cool the horse down. All of these prior arts require many people, allow the people to get drenched, can upset the horse and increase the time to cool down the horse. The present invention overcomes the limitations of the prior art. That is, the art of the present invention, a portable apparatus for cooling and washing a horse, provides an insulated container on wheels with a handle with an exterior battery and an exterior pump with a Y connector to attach the hoses to the pump and container and two wands to attach to the hoses. Prior arts do not provide a container that is easy to transport on wheels with a handle. Also prior arts do not provide a battery and pump to pump water from the container, as well as the prior arts do not provide a Y connector to attach hoses and wands to wash, scrap and dry the animal easily with out getting the person or people drenched or upsetting the animal. The also do not provide an insulated container, which allows for preparation prior to uses with water and ice that stays cooled for extended periods of time, while allowing for easy transportation. Prior arts also do not provide as quick of a cooling process as the PHC Portable horse cooler sprays water as well as scraps the water of almost immediately allowing for quicker cooling.

### BRIEF SUMMARY OF THE INVENTION

The present invention can be transported to a desired location and used without the need of a water source or power. The container receives water from buckets or from an exterior hose prior to transport. The present invention has an integrated battery and pump system and allows the hoses and wands to retrieve water that cooperate to allow the owner to cool and wash all of a horse or animal quickly and thoroughly. The wands prevent the owner from getting drenched while allowing a complete cooling and or washing of a horse or animal. The container of the present invention serves to hold the water and keep it cold or warm and has a battery and pump to allow the water to flow out through the hoses and wands easily. The present invention minimizes mess during washing and allows for a wash at the location of the owner's choosing.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved portable cooling and/or washing apparatus for horse and/or animals that has all of the advantages of the prior art and none of the disadvantages.

It is another object of the present invention to provide a portable cooling and/or washing apparatus for animals that may be easily and efficiently manufactured and marketed.

### BRIEF DESCRIPTION OF THE SEVERAL VIEWS OF THE DRAWINGS

FIG. 1 shows a front view of the PHC Portable Horse Cooler according to the embodiment of the present invention.

FIG. 1 has a front view of present embodiment of the present invention with the view of the Insulated Container with Lid.

FIG. 1 has a front view of present embodiment of the present invention with the view of the fixed Exterior Pipe with Filter.

FIG. 1 has a front view of present embodiment of the present invention with the view of the fixed Exterior Battery.

FIG. 1 has a front view of present embodiment of the present invention with the view of the fixed Exterior Pump.

FIG. 1 shows a front view of the present embodiment of the present invention with the view of the Y Connector, Hoses and Wands connected together and to the Pump.

FIG. 1 has a front view of present embodiment of the present invention with the view of the Wand Shut Off.

FIG. 1 has a front view of present embodiment of the present invention with the view of the fixed Extending Handle.

FIG. 1 has a front view of present embodiment of the present invention with the view of the fixed Side Handles.

FIG. 1 has a front view of present embodiment of the present invention with the view of the Quick Release.

FIG. 1 has a front view of present embodiment of the present invention with the view of the Battery Pack with a fixed Charger Plug in Port.

FIG. 1 has a front view of present embodiment of the present invention with the view of the Charger Plug In.

FIG. 1 has a front view of present embodiment of the present invention with the view of the Battery Pack with a fixed Power On/Off Switch.

FIG. 1 has a front view of present embodiment of the present invention with the view of the Battery Pack with a fixed Battery Level Button.

FIG. 1 has a front view of present embodiment of the present invention with the view of the Battery Pack with a fixed Bi-Colored Power On/Charging Indicator.

FIG. 1 has a front view of present embodiment of the present invention with the view of the Battery Pack with three fixed Battery Power Level Indicators.

FIG. 1 has a front view of present embodiment of the present invention with the view of the Battery Pack with a fixed Extra Power Port.

FIG. 1 has a front view of present embodiment of the present invention with the view of the wires connecting the power from the Battery Pack to the Pump

FIG. 2 shows a side view of the PHC Portable Horse Cooler according to the embodiment of the present invention.

FIG. 2 shows a side view of the present embodiment of the present invention with the view of the Wheel.

FIG. 2 shows a side view of the present embodiment of the present invention with the view of the Extending Handle.

FIG. 2 shows a side view of the present embodiment of the present invention with the view of the Side Handle.

FIG. 2 shows a side view of the present embodiment of the present invention with the view of the Insulated Container with Lid.

### DETAILED DESCRIPTION OF THE INVENTION

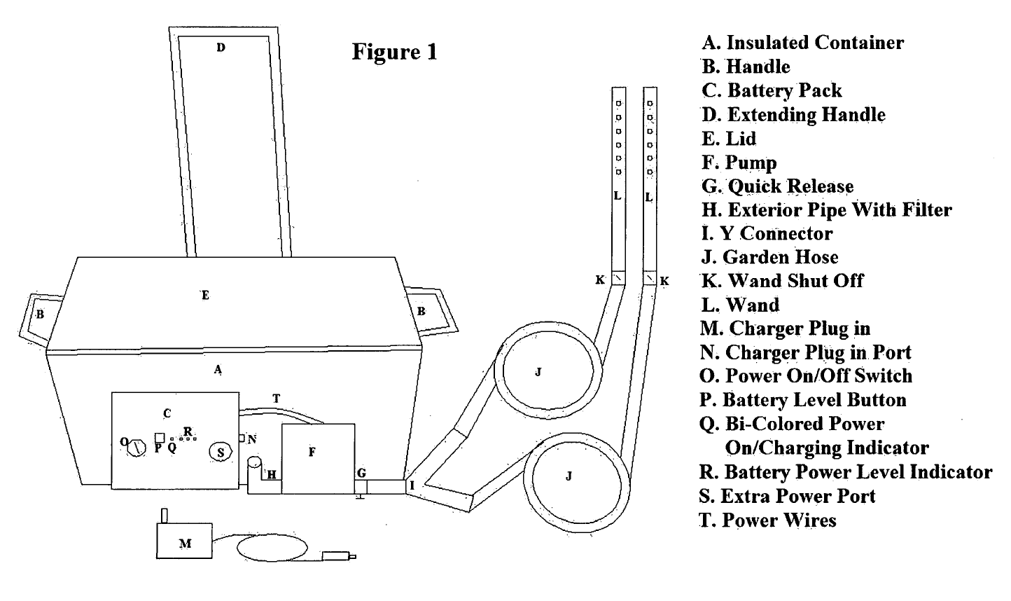

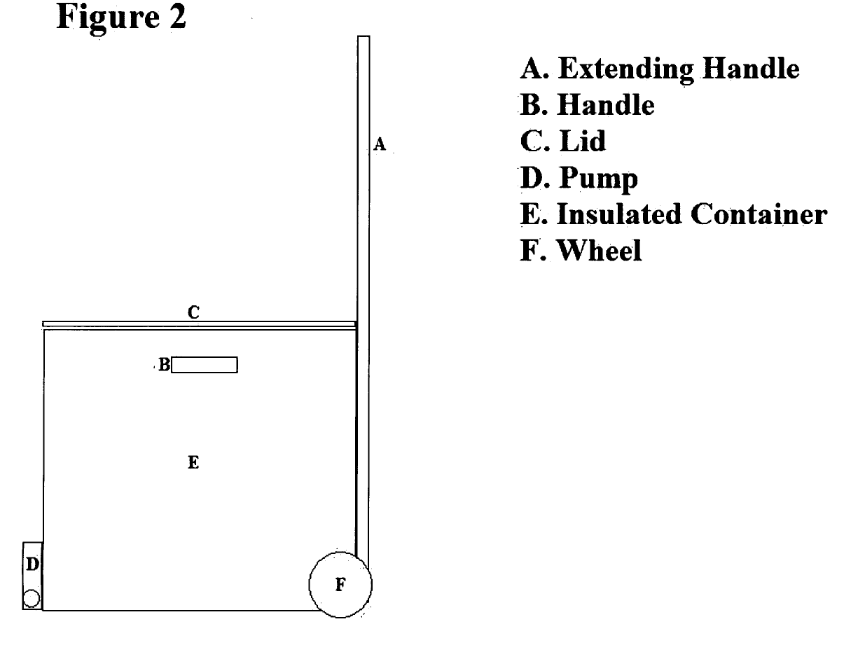

The PHC Portable Horse Cooler is an insulated container of different sizes with wheels and a handle for easy transportation as well as it has an exterior battery, an exterior pump, a hose or hoses and a wand or wands for a cooling or bathing a horse or other animal. As the PHC Portable Horse Cooler has a pump, battery, and two hoses that allow water to flow to two wands that have a sprayer and a sweat scraper built in one. The battery and pump allow for use in almost any situation and/or location with out the use of a water hook up or an electrical outlet. It also allows for multiple uses as the battery has a built in rechargeable system. The person on each side can wet the horse with the hose and scrap off the water at the same time and then when finished cooling the horse off, the person can turn the off switch off the wand and scrap the horse off completely. This PHC Portable Horse Cooler apparatus allows the owners and volunteers to stay dry and requires less people to cool the horse which allows the horse to remain calm and the process can be accomplished more quickly. Also the PHC Portable Horse Cooler apparatus is on wheels and has a handle which when empty and dry, all of the hoses and wands can fit conveniently inside the cooler and can be wheeled easily and stored all together until it is needed again. The present invention overcomes the prior art limitations by providing a insulated container with easily transportable unit that has an exterior re-chargeable battery with on and off switch battery level button, bi-colored power on/charging indicator, battery power level indicator, exterior pump, hoses, quick release and wands for cooling and/or washing horses or animals. FIG. 1 shows the major components of the present invention. The present invention allows for placing water, ice or the like in the insulated container that will be cold for an extended period of time. The current arts do not allow extended time for storage of cooled water, which puts a time hindrance on use. The present invention upon turning on the battery by turning the power switch to the on position gives power to the pump and turns on the pump and proceeds to pump water from the container discharging water out through the hoses and wands. In FIG. 1, the insulated container with lid is displayed and the pump, battery, quick release, exterior pipe with filter, y connector, hoses, and shut offs, wands, charger plug in port, charger plug in, power on and off switch, battery level button, bi colored power on/charging indicator, battery power level indicator, extra power port, wires and handles are easy to see.

In FIG. 1 beneath the lid, the present invention has a base that contacts a supporting surface such as the ground or the floor. The base and sides are connected and the inside space can hold water and/or ice. The exterior battery pack in FIG. 1 is fixed and secured permanently to the outside of the container. The battery pack comes with a charging jack and AC adapter which is in FIG. 1. The pump in FIG. 1 is permanently fixed to the exterior of the insulated container in FIG. 1. The exterior pipe with filter is permanently connected to the insulated container and the pump in FIG. 1. The exterior pipe with filter allows for the flow of water from the insulated container to the pump. The pump is a self priming pump. The pump is connected to the battery pack by two wires in FIG. 1 as well as the battery provides power to the pump when the power on/off switch is turned to the on position. The quick release has half permanently attached to the pump and the other half is threaded to the y connector. This allows the operator to use one or two hoses at a time at the operator's choice. Upon insertion of the half connected to the y connector in to the half permanently connected to the pump it automatically locks in place. To release the two halves a person simply pulls down on a switch and the two halves separate. By removing the quick connect and turning the pump on will drain the water from the container. The y connector in FIG. 1 fixed to the quick release allows for a single hose to be used or multiple hoses to be used. The two hoses in FIG. 1 allow water to be carried from the container via the pump to the wands to cool and/or wash the horse or animal. The two wands in FIG. 1 are necessary to allow the water to spray the horse or animal and also allow the horse or animal to have the water scraped off afterward, which keeps the people using the PHC Portable Horse Cooler to not get drenched with water.

The lid provides an upper component of the container. The lid is on hinges which allows it to be opened and water and/or ice can in inserted through the top of the insulated container.

From the aforementioned description, a portable cooling and/or washing apparatus for horse or animals has been described. The PHC Portable Horse Cooler for animals is uniquely capable of cooling and spraying the animal such as a horse or animal without soaking a person. The present invention for animals and its various components may be manufactured from many materials, including but not limited to polymers, polyvinyl chloride, high density polyethylene, polypropylene, fiberglass, rubber, latex, nylon, ferrous and non-ferrous metals, lead-acid battery, their alloys, composites and etc.

1. A portable container, comprising: a portable insulated storage compartment having an outer surface and an opening on the top through which water and/or ice can be inserted into and removed from the storage compartment; a closure that moves from an open position permitting access to the storage compartment via the opening to a closed position wherein the closure substantially covers the opening.

2. The container of claim 1 wherein has wheels attached to the exterior.

3. The container of claim 1 wherein has an extendable handle and side handles attached to the exterior.

4. The container of claim 1 wherein the storage compartment has outer surfaces that are exposed to the environment and at least those outer surfaces exposed to the environment are insulated.

5. The container of claim 1 wherein has permanently attached to its exterior a rechargeable battery.

6. The rechargeable battery of claim 5 wherein has permanently attached to its exterior a protective case composed of plastic.

7. The protective case of claim 6 wherein the protective case has an on and off switch permanently attached to it, which is connected by two wires to the rechargeable battery of claim 5.

8. The protective case of claim 6 wherein the protective case has battery level button attached to it, which is connected by two wires to the rechargeable battery of claim 5.

9. The protective case of claim 6 wherein the protective case has battery power level indicators attached to it, which is connected by two wires to the battery level button of claim 8.

10. The protective case of claim 6 wherein the protective case has a bi-colored on/charging indicator attached to it, which is connected by two wires to the rechargeable battery of claim 5.

11. The protective case of claim 6 wherein the protective case has a charging jack with and AC/DC charging adapter attached to it, which is connected by two wires to the bi-colored on/charging indicator of claim 10.

12. The container of claim 1 wherein has attached to its exterior a water pump, which is connected by two wires to the rechargeable battery of claim 5.

13. The water pump of claim 12 wherein has attached to its exterior a quick release connector to attach a garden hose or the like.

14. The container of claim 1 wherein has attached to its exterior a pipe with a filter, which connects to the pump of claim 12.

15. The quick release connector of claim 13 wherein has attached to it a garden hose or the like.

16. The garden hose or the like of claim 15 wherein has attached to it a spraying apparatus or the like.

17. The pipe of claim 14 allows for the water to flow from the container of claim 1 to the pump of claim 12.

18. The pump of claim 12 receives electrical power and begins pumping water when the on and off switch of claim 7 is turned to the on position.

19. The water of claim 17 is forced under pressure through the quick release connector of claim 13, through the garden hose or the like of claim 15, through the spraying apparatus or the like of claim 16, and onto the animal.

20. After claim 19 occurs the water of claim 17 creates a cooling and/or cleaning of the animal.
